(19) United States
(12) Patent Application Publication
(10) Pub. No.: US 2026/0270389 A1
(43) Pub. Date: Sep. 10, 2026

(54) IMAGE PROCESSING DEVICE, HEAD MOUNTED DISPLAY, AND IMAGE PROCESSING METHOD

(71) Applicant: CANON KABUSHIKI KAISHA, Tokyo (JP)

(72) Inventor: YOSHIHIRO MIZUO, Tokyo (JP)

(21) Appl. No.: 19/662,917

(22) Filed: Apr. 29, 2026

Related U.S. Application Data
(63) Continuation of application No. PCT/JP2024/029087, filed on Aug. 15, 2024.

(30) Foreign Application Priority Data
Nov. 8, 2023 (JP) 2023-190565

(51) Int. Cl. H04N 13/398; H04N 13/00; H04N 13/239; H04N 13/344

(52) U.S. Cl. CPC H04N 13/398; H04N 13/239; H04N 13/344; H04N 2013/0081

(57) ABSTRACT

An image processing device includes a processor; and a memory storing a program which, when executed by the processor, causes the image processing device to: acquire a first image for a right eye and a second image for a left eye; acquire a depth distance of an object detected in the first image and the second image from a user; control a display position of a first object on a display on a basis of a first depth distance that is the depth distance of the first object detected in the first image and the second image, and control a display position of a second object on the display on a basis of a second depth distance that is the depth distance of the second object detected in the first image and the second image.

### CROSS-REFERENCE TO RELATED APPLICATIONS

This application is a Continuation of International Patent Application No. PCT/JP2024/029087, filed Aug. 15, 2024, which claims the benefit of Japanese Patent Application No. 2023-190565, filed Nov. 8, 2023, both of which are hereby incorporated by reference herein in their entirety.

### BACKGROUND

### Field of the Technology

The present disclosure relates to an image processing device, a head mounted display, and an image processing method.

### Description of the Related Art

With the recent spread of a head mounted display (HMD), a user can experience a space in which a depth in an image is felt by viewing a left-eye image and a right-eye image with left and right eyes, respectively. At this time, since the positions of the left and right eyes of the user are different from the positions of imaging devices that capture the left-eye image and the right-eye image, the actual depth may be different from the depth when the user views the image with the HMD. U.S. Patent Application Publication No. 2021/0043170 discloses a technique for correcting a difference in depth by entirely shifting a left-eye image and a right-eye image.

When the left-eye image and the right-eye image are entirely shifted, a sense of distance of an object at a specific depth distance can be corrected according to the actual depth distance. However, it is difficult to correct a plurality of objects existing at different depth distances so as to be displayed at the actual depth distances.

### SUMMARY

The present disclosure provides an image processing device capable of controlling a plurality of objects existing at different depth distances to be displayed at respective actual depth distances.

A first aspect of the present disclosure is an imaging processing device including a processor; and a memory storing a program which, when executed by the processor, causes the image processing device to: execute image acquisition processing of acquiring a first image for a right eye and a second image for a left eye; execute distance acquisition processing of acquiring a depth distance of an object detected in the first image and the second image from a user; and execute display control processing of controlling a display position of a first object on a display on a basis of a first depth distance that is the depth distance of the first object detected in the first image and the second image, and controlling a display position of a second object on the display on a basis of a second depth distance that is the depth distance of the second object detected in the first image and the second image.

A second aspect of the present disclosure is an image processing method including: acquiring a first image for a right eye and a second image for a left eye; acquiring a depth distance of an object detected in the first image and the second image from a user; and controlling a display position of a first object on a display on a basis of a first depth distance that is the depth distance of the first object detected in the first image and the second image, and controlling a display position of a second object on the display on a basis of a second depth distance that is the depth distance of the second object detected in the first image and the second image.

A third aspect of the present disclosure is a non-transitory computer readable medium that stores a program, wherein the program causes a computer to execute an image processing method including: acquiring a first image for a right eye and a second image for a left eye; acquiring a depth distance of an object detected in the first image and the second image from a user; and controlling a display position of a first object on a display on a basis of a first depth distance that is the depth distance of the first object detected in the first image and the second image, and controlling a display position of a second object on the display on a basis of a second depth distance that is the depth distance of the second object detected in the first image and the second image.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are external diagrams of an HMD.

FIG. 2 is a block diagram exemplifying a configuration of the HMD.

FIG. 3 is a flowchart for describing display position correction processing of an object.

FIGS. 4A and 4B are diagrams exemplifying a situation in which a plurality of objects having different depths are detected.

FIGS. 5A, 5C, and 5E are diagrams exemplifying a left-eye image. FIGS. 5B, 5D, and 5F are diagrams exemplifying a right-eye image.

FIGS. 6A and 6B are diagrams for describing calculation of a depth distance of an object.

FIGS. 7A to 7C are diagrams for describing a method of calculating a correction amount with respect to a display position of a dog.

FIGS. 8A to 8C are diagrams for describing a method of calculating a correction amount with respect to a display position of a person.

### DESCRIPTION OF THE EMBODIMENTS

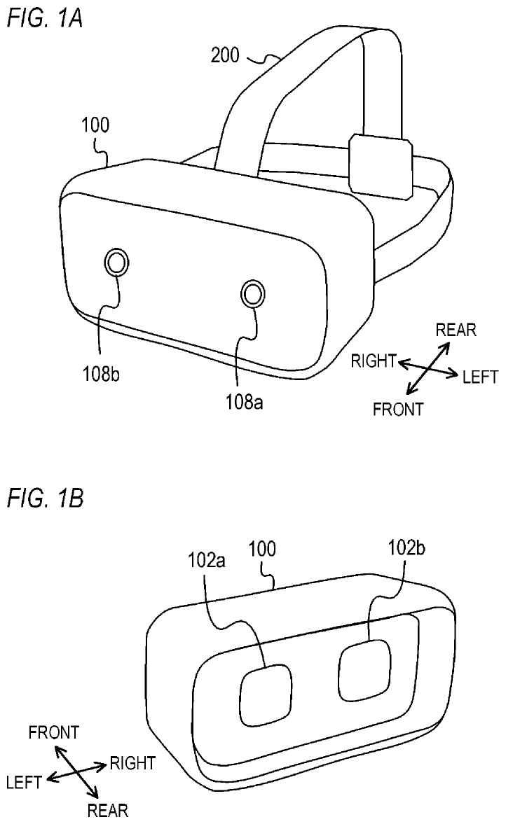

Hereinafter, an embodiment of the present disclosure will be described in detail with reference to the accompanying drawings. FIGS. 1A and 1B are external diagrams of a head mounted display (HMD) 100 as an image processing device according to the present disclosure. The HMD 100 includes a left imaging device 108a for the left eye, a right imaging device 108b for the right eye, a left eyepiece part 102a for the left eye, and a right eyepiece part 102b for the right eye.

FIG. 1A is a front perspective view of the HMD 100. The HMD 100 is connected to a headband 200. The headband 200 fixes the HMD 100 to the head of the user. Hereinafter, the user wearing the HMD 100 is also simply referred to as a user. The left imaging device 108a and the right imaging device 108b photograph the outside to generate a left-eye display image (left-eye image) and a right-eye display image (right-eye image), respectively.

FIG. 1B is a rear (back) perspective view of the HMD 100. The left eyepiece part 102a and the right eyepiece part 102b are members for the user to align the left eye and the right eye, respectively. The user can visually recognize the left-eye image and the right-eye image through the left eyepiece part 102a and the right eyepiece part 102b.

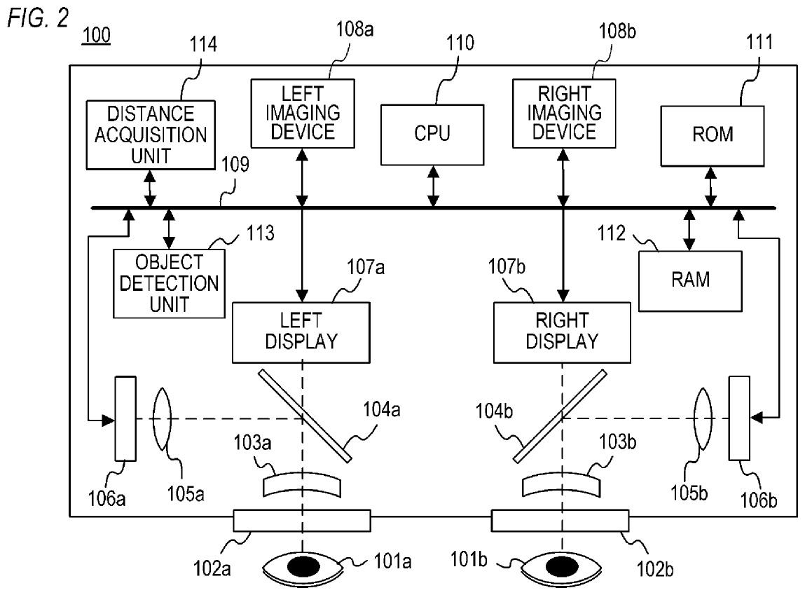

FIG. 2 is a block diagram exemplifying a configuration of the HMD 100. A left eye 101a and a right eye 101b represent the left and right eyeballs of the user, respectively. The HMD 100 includes the left eyepiece part 102a for the left eye, the right eyepiece part 102b for the right eye, a left eyepiece 103a for the left eye, a right eyepiece 103b for the right eye, a left optical splitter 104a for the left eye, and a right optical splitter 104b for the right eye. In addition, the HMD 100 includes a left light receiving lens 105a for the left eye, a right light receiving lens 105b for the right eye, a left imaging element 106a for the left eye, and a right imaging element 106b for the right eye. In addition, the HMD 100 includes the left display 107a for the left eye, the right display 107b for the right eye, the left imaging device 108a, the right imaging device 108b, and a bus 109. In addition, the HMD 100 includes a central processing unit (CPU) 110, a read only memory (ROM) 111, a random access memory (RAM) 112, an object detection unit 113, and a distance acquisition unit 114. The blocks included in the HMD 100 can mutually transmit and receive data via the bus 109.

FIG. 2 illustrates an example in which an image processing device according to the present disclosure is configured as a part of the HMD 100. The present disclosure is not limited thereto, and the image processing device may be configured as a device separate from the HMD 100. In this case, the image processing device includes the CPU 110, the ROM 111, the RAM 112, the object detection unit 113, and the distance acquisition unit 114.

The left eyepiece part 102a and the right eyepiece part 102b are members through which the user looks into the left-eye image and the right-eye image. The left eyepiece 103a and the right eyepiece 103b are used to focus an image viewed by the user. The left optical splitter 104a and the right optical splitter 104b are optical splitters for splitting the image information of the left eye 101a and the right eye 101b into a line-of-sight detection system. The light dispersed by the left optical splitter 104a and the right optical splitter 104b is transmitted to the left imaging element 106a and the right imaging element 106b through the left light receiving lens 105a and the right light receiving lens 105b. The image information of the left eye 101a and the right eye 101b formed by the left imaging element 106a and the right imaging element 106b, respectively, is transmitted to other blocks through the bus 109.

The left display 107a and the right display 107b display images captured by the left imaging device 108a and the right imaging device 108b, respectively, and superimpose and display an image of a virtual object. The left imaging device 108a and the right imaging device 108b are arranged on the left and right at a distance, and capture two images (left-eye image and right-eye image) with parallax.

The CPU 110 controls the entire HMD 100 by executing various types of image processing and various types of calculation processing using values calculated in other blocks. For example, the CPU 110 executes processing of detecting the line-of-sight position from the eye images captured by the left imaging element 106a and the right imaging element 106b, and processing of extracting various information from the images captured by the left imaging device 108a and the right imaging device 108b.

The ROM 111 stores a program for realizing processing executed by the CPU 110 and data used for processing executed by the CPU 110. The RAM 112 stores images captured by the left imaging element 106a, the right imaging element 106b, the left imaging device 108a, and the right imaging device 108b as digital data. In addition, the RAM 112 is used as a work memory that temporarily stores data used when the CPU 110 executes processing.

The object detection unit 113 acquires images captured by the left imaging device 108a and the right imaging device 108b, and detects an object existing in the acquired images. The object detection unit 113 can acquire information such as a position, a type, and a size of the detected object.

From the difference information between the two images captured by the left imaging device 108a and the right imaging device 108b, the distance acquisition unit 114 acquires how far the object detected in the two images is physically away from the HMD 100. That is, the distance acquisition unit 114 can acquire an actual distance (hereinafter, also referred to as a depth distance) from the user wearing the HMD 100 to the object. The distance acquisition unit 114 can acquire how far not only the object detected in the two images but also each pixel of the entire image is physically away from the HMD 100.

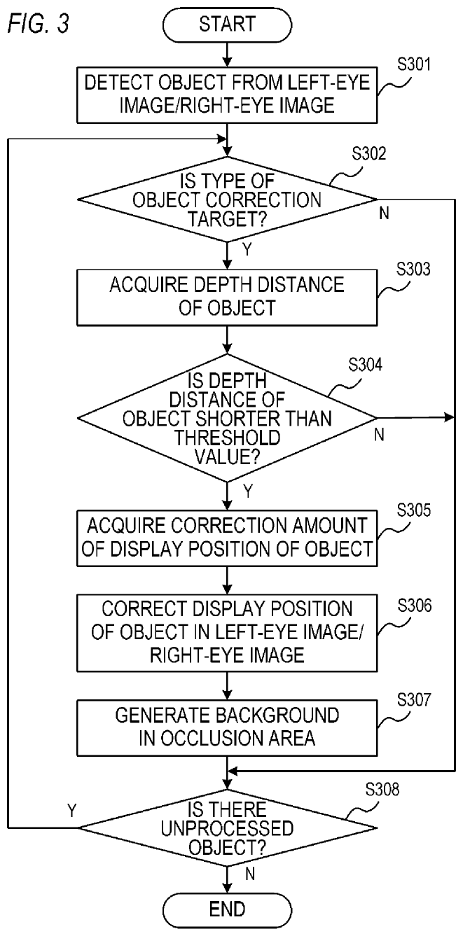

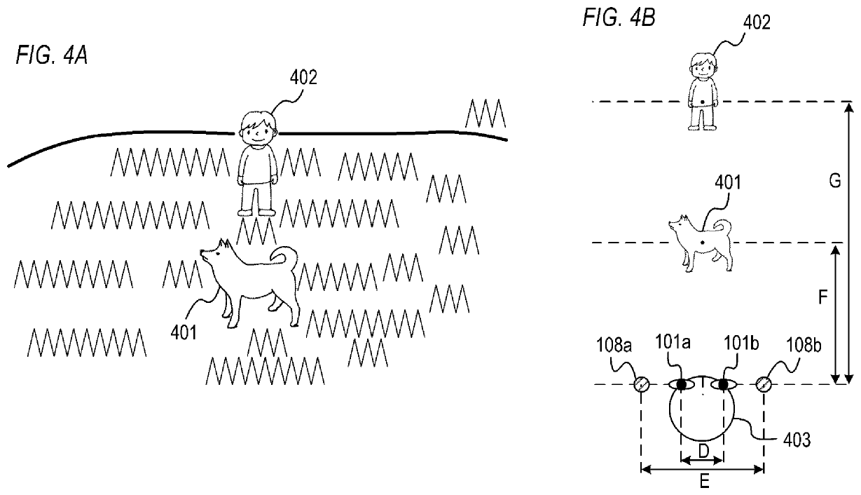

FIG. 3 is a flowchart exemplifying display position correction processing of an object. Hereinafter, the flow of the processing illustrated in FIG. 3 will be described with reference to FIGS. 4 to 8.

In step S301, the CPU 110 causes the object detection unit 113 to detect an object from the left-eye image and the right-eye image captured by the left imaging device 108a and the right imaging device 108b, respectively. The left-eye image and the right-eye image may be recorded images. The object detection unit 113 (image acquisition means) can acquire the recorded left-eye image and right-eye image stored in a storage unit such as the ROM 111, for example. In addition, the object detection unit 113 may acquire the left-eye image and the right-eye image from an external device.

The CPU 110 acquires position and type information for each detected object. The position of the object is represented by coordinates on the two-dimensional image. The type of the object is, for example, a type indicating a feature of an object such as a person or a dog, and can be determined in advance.

FIGS. 4A and 4B are diagrams for describing a situation in which a plurality of objects having different depths are detected. FIG. 4A illustrates a situation in which a dog 401 and a person 402 exist as objects at different distances from the user in real space.

FIG. 4B is a schematic overhead diagram of the situation of FIG. 4A including a user 403 wearing the HMD 100. The distance between the left eye 101a and the right eye 101b is D, and the distance between the imaging devices of the left imaging device 108a and the right imaging device 108b is E. The distance from the user 403 to the dog 401 is F, and the distance from the user 403 to the person 402 is G.

The CPU 110 executes processing from step S302 to step S307 on each of the objects detected in step S301. In the example of FIG. 4A, the CPU 110 executes the processing from step S302 to step S307 on two objects, the dog 401 and the person 402.

In steps S302 and S304, the CPU 110 determines whether or not the objects detected in step S301 are targets for correcting the display position. In a case where the detected object satisfies a predetermined condition, the CPU 110 corrects the display position of the object. The predetermined condition determined in step S302 is a condition that the type of the object is a type determined in advance as a correction target. The predetermined condition determined in step S304 is a condition that the depth distance of the object is shorter than a predetermined threshold value.

Note that the predetermined condition is not limited to the condition on the type of the object and the depth distance of the object. The predetermined condition may be, for example, a condition on the size of the object, the position of the object in the captured image, and the like. Furthermore, the CPU 110 may change the threshold value for determining whether or not the predetermined condition is satisfied, for example, according to the number of objects detected in the image.

In addition, the processing illustrated in FIG. 3 illustrates an example of correcting the display position of object when the object satisfies the predetermined condition for both the type and the depth distance, but is not limited thereto. The CPU 110 may correct the display position of object when the object satisfies the predetermined condition for either the type or the depth distance. In addition, the CPU 110 may correct all the display positions of objects detected in the left and right captured images without determining the predetermined condition.

In step S302, the CPU 110 determines whether or not the type of the object is the type of the correction target. The type of the correction target is a type determined in advance as a target of the display position correction processing. In the example of FIG. 4A, the dog and the person are the types of the correction target.

In a case where the type of an object is a correction target, the processing proceeds to step S303. In a case where the type of an object is not a correction target, the processing proceeds to step S308. In step S302, the CPU 110 narrows down objects to be corrected by determining the type of the object. By narrowing down the objects to be corrected to objects of a predetermined type determined in advance, the CPU 110 can reduce the processing load. The predetermined type can be, for example, a type of an object for which a correction effect can be obtained in actual use, or a type of an object on which the user focuses. In a case where the object is the dog 401, since the dog that is the type of the dog 401 is a correction target, the processing proceeds to step S303.

In step S303, the CPU 110 causes the distance acquisition unit 114 to acquire the depth distance of the object. In a case where the object is the dog 401 in FIG. 4A, the distance acquisition unit 114 can calculate an actual depth distance from the difference in the position of the dog 401 in the images individually captured by the left imaging device 108a and the right imaging device 108b.

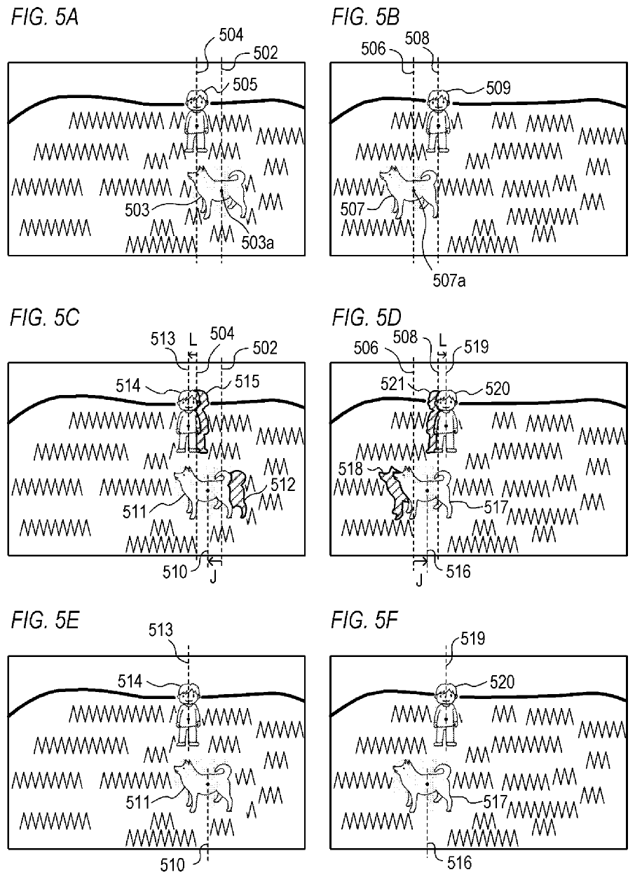

FIGS. 5A and 5B illustrate examples of images captured by the left imaging device 108a and the right imaging device 108b, respectively. A dog 503 (dog 401) in the left-eye image of FIG. 5A exists at a position 502 in the horizontal direction. A dog 507 (corresponding to the dog 503 in the left-eye image) in the right-eye image of FIG. 5B exists at a position 506 in the horizontal direction. The distance acquisition unit 114 can calculate a depth distance F from the HMD 100 to the dog 503 (dog 507) using the distance (difference in position) between the position 502 and the position 506.

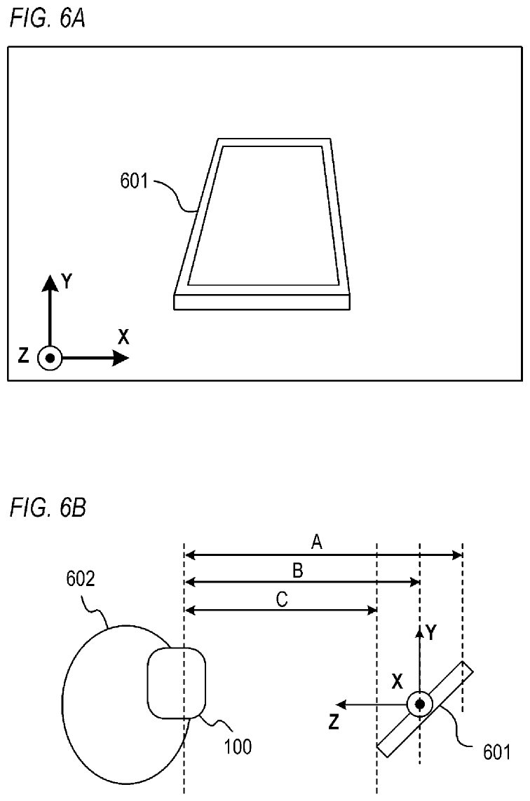

FIGS. 6A and 6B are diagrams for describing calculation of a depth distance. In the examples of FIGS. 5A and 5B, the depth distance F is calculated from a difference between positions (for example, the position 503a of the dog 503, the position 507a of the dog 507) representing objects (dog 503 and dog 507) in the left-eye image and the right-eye image. On the other hand, as illustrated in FIG. 6A, even in the case of the same object existing at a short distance such as a smartphone 601 placed at hand, a difference in depth distance is larger than that of the dog 503 in FIG. 5A.

As illustrated in FIG. 6B, a distance A is a distance from the HMD 100 worn by a user 602 to the upper end of the smartphone 601, and a distance C is a distance from the HMD 100 to the lower end of the smartphone 601. In addition, a distance B is a distance from the HMD 100 to the midpoint of the smartphone 601.

In a case where there is a difference in the depth distance as described above, the distance acquisition unit 114 calculates the distance from the user to the center of the object as a depth distance. The center of the object may be, for example, a midpoint between an upper end and a lower end of the object, or may be a center of gravity of the object. In addition, the distance to the center of the object may be an average value of the depth distance of the upper end of the object and the depth distance of the lower end of the object.

In step S304 of FIG. 3, the CPU 110 determines whether or not the depth distance of the object calculated in step S303 is shorter than a predetermined threshold value. If the depth distance of the object is shorter than the predetermined threshold value, the processing proceeds to step S305. If the depth distance of the object is greater than or equal to the predetermined threshold value, the processing proceeds to step S308. In the example of FIG. 4B, it is determined that the depth distance F of the dog 401 is shorter than the predetermined threshold value, and the processing proceeds to step 305.

In step S304, the CPU 110 narrows down a processing target by determining a depth distance of an object. The CPU 110 can reduce the processing load by narrowing down an object to be processed to an object having a depth distance shorter than the predetermined threshold value. The reason why an object to be processed is narrowed down to an object having a depth distance shorter than the threshold value is that, as the depth distance of the object is shorter, the effect of suppressing the deviation of a sense of depth due to the correction of the display position can be obtained. The threshold value for determining the depth distance may be determined in advance according to, for example, a range in which the user intends to capture an image. In addition, the threshold value may be set or changed such that the number of objects to be corrected is the number according to the processing capability of the HMD 100.

In step S305, the CPU 110 acquires a correction amount of a display position of an object. The CPU 110 can acquire the correction amount of the display position of the object on the basis of the depth distance of the object acquired in step S303, a distance D between the left eye 101a and the right eye 101b, and a distance E between imaging devices of the left imaging device 108a and the right imaging device 108b.

The distance D between the left eye 101a and the right eye 101b may be measured and held for each user in advance, and can also be acquired from an eye image captured by the left imaging element 106a and the right imaging element 106b. The distance E between the left and right imaging devices is held in advance as a design value.

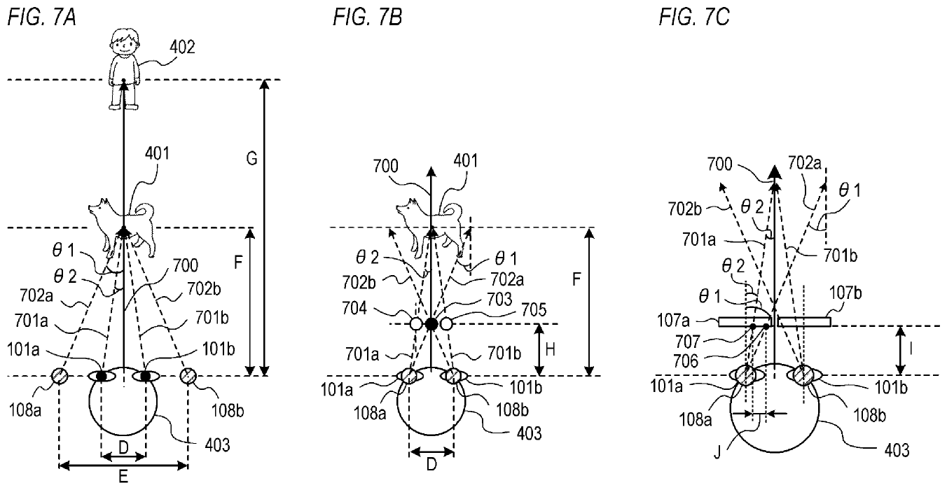

The processing of step S305 on the dog 401 will be specifically described with reference to FIGS. 7A to 7C. FIG. 7A is a diagram for describing at what angle the dog 401 is captured from each of the left eye 101a, the right eye 101b, the left imaging device 108a, and the right imaging device 108b.

A center line 700 is a straight line extending from the midpoint between the left and right eyes in the direction in which the dog 401 exists. The left imaging device 108a captures the dog 401 with a left imaging device line of sight 702a in which an angle formed with the center line 700 is an angle θ1. The right imaging device 108b captures the dog 401 with the right imaging device line of sight 702b in which an angle formed with the center line 700 is the angle θ1. The angle θ1 is expressed by the following Formula 1 using the distance E between the left and right imaging devices and the depth distance F of the dog 401.

$$\begin{matrix}[ Math . 1 ] & \\ {θ}_{1} = {tan}^{- 1} ( \frac{E / 2}{F} ) & ( Formula 1 )\end{matrix}$$

The left eye 101a captures the dog 401 with a left-eye line of sight 701a in which an angle formed with the center line 700 is an angle θ2. The right eye 101b captures the dog 401 with a right-eye line of sight 701b in which an angle formed with the center line 700 is the angle θ2. The angle θ2 is expressed by the following Formula 2 using the distance D between the left eye 101a and the right eye 101b and the depth distance F of the dog 401.

$$\begin{matrix}[ Math . 2 ] & \\ {θ}_{2} = {tan}^{- 1} ( \frac{D / 2}{F} ) & ( Formula 2 )\end{matrix}$$

As schematically illustrated in FIG. 7B, the user 403 actually views images captured by the left imaging device 108a and the right imaging device 108b with his/her left eye 101a and right eye 101b, respectively. In the state of FIG. 7B, the left eye 101a captures the dog 401 on the left imaging device line of sight 702a in which an angle formed with the center line 700 is the angle θ1, and the right eye 101b captures the dog 401 on the right imaging device line of sight 702b in which an angle formed with the center line 700 is the angle θ1. In this case, the user 403 recognizes that the dog 401 exists at a position 703 where the left imaging device line of sight 702a and the right imaging device line of sight 702b intersect. A depth distance H from the user 403 to the position 703 is expressed by the following Formula 3. The depth distance H is a distance shorter than the actual depth distance F from the user 403 to the dog 401.

$$\begin{matrix}[ Math . 3 ] & \\ H = \frac{( D / 2 )}{tan {θ}_{1}} & ( Formula 3 )\end{matrix}$$

If the left eye 101a can capture the dog 401 on the left-eye line of sight 701a and the right eye 101b can capture the dog 401 on the right-eye line of sight 701b, the user 403 can capture the dog 401 with an actual sense of distance, and can recognize that the dog 401 exists at the position of the distance F from the user 403. In the depth distance H, it is only required to capture the dog 401 by the left eye 101a at a position 704 on the left-eye line of sight 701a, and by the right eye 101b at a position 705 on the right-eye line of sight 701b. The CPU 110 corrects the display position of the dog 401 with the left-eye image and the right-eye image, so that the left eye 101a and the right eye 101b can capture the dog 401 at the position 704 and the position 705.

FIG. 7C is a diagram for describing the correction amount of the display position of the dog 401 in the left-eye image and the right-eye image. A distance from the user 403 to the left display 107a and the right display 107b is I. Hereinafter, a method of calculating the correction amount for the left-eye image will be described, but the correction amount for the right-eye image can be calculated similarly to the case of the left-eye image.

In a state where the dog 401 is captured at the position 703 on the left imaging device line of sight 702a in FIG. 7B, the dog 401 is displayed at a position 706 on the left display 107a in FIG. 7C. The dog 401 is displayed at a position 707 where the left-eye line of sight 701a and the left display 107a intersect, so that the left eye 101a of the user 403 can capture the dog 401 at the position 704 on the left-eye line of sight 701a in FIG. 7B. A distance J between the position 706 on the left imaging device line of sight 702a and the position 707 on the left eye line of sight 701a is a correction amount by which the dog 401 is to be moved on the left display 107a. The distance J, which is a correction amount, is expressed by the following Formula 4.

$$\begin{matrix}[ Math . 4 ] & \\ J = I \cdot ( tan {θ}_{1} - tan {θ}_{2} ) & ( Formula 4 )\end{matrix}$$

Similarly, the dog 401 is moved by the distance J in the direction away from the center line 700 on the right display 107b, so that the right eye 101b of the user 403 can capture the dog 401 at the position 705 on the right-eye line of sight 701b of FIG. 7B.

In step S306 of FIG. 3, the CPU 110 controls the display position of the object in the left-eye image and the right-eye image. The CPU 110 performs display control of the object by correcting the predetermined display position of the object by the correction amount based on the depth distance acquired in step S305. Specifically, the CPU 110 cuts out an area of the object (dog 401) from the left-eye image and the right-eye image, and moves the area of the object cut out by the correction amount acquired in step S305.

The CPU 110 cuts out an image area of the dog 503 at the position 502 on the left-eye image illustrated in FIG. 5A, and moves the image area by the correction amount (distance J) acquired in step S305. A dog 511 illustrated in FIG. 5C is the dog 503 of FIG. 5A moved to a position 510. In FIG. 5A, in the area where the dog 503 is displayed before the correction, an area where the moved corrected dog 511 is not displayed (an area not overlapping with the corrected dog 511) is an occlusion area 512 where no image exists.

Similarly, the CPU 110 cuts out an image area of the dog 507 at the position 506 on the right-eye image illustrated in FIG. 5B, and moves the image area by the correction amount (distance J) acquired in step S305. A dog 517 illustrated in FIG. 5D is the dog 507 of FIG. 5B moved to a position 516. In FIG. 5B, in the area where the dog 507 is displayed before the correction, an area where the moved corrected dog 517 is not displayed (an area not overlapping with the corrected dog 517) is an occlusion area 518 where no image exists.

In step S307, the CPU 110 estimates and generates a background in the occlusion area generated in step S306. FIGS. 5E and 5F illustrate images in which backgrounds are estimated and generated for the occlusion areas 512 and 518 in FIGS. 5C and 5D, and the generated images are fitted. The CPU 110 estimates and generates an image of each occlusion area from an image around each of the occlusion area 512 in the left-eye image and the occlusion area 518 in the right-eye image. FIGS. 5E and 5F illustrate states in which the backgrounds are fitted into the occlusion areas 512 and 518 in FIGS. 5C and 5D, and the dogs 503 and 507 in FIGS. 5A and 5B are moved to the positions of the dogs 511 and 517, respectively.

In step S308, the CPU 110 determines whether or not there is an unprocessed object on which the display position correction processing has not been executed among the objects detected in step S301. If there is an unprocessed object, the CPU 110 returns to step S302 and executes the processing of steps S302 to S307 on the unprocessed object. If there is no unprocessed object, the processing illustrated in FIG. 3 ends.

In the example illustrated in FIG. 4A, since the dog 401 and the person 402 are detected as objects, the CPU 110 executes the processing on the dog 401 and then executes the processing of steps S302 to S307 on the person 402 serving as an unprocessed object.

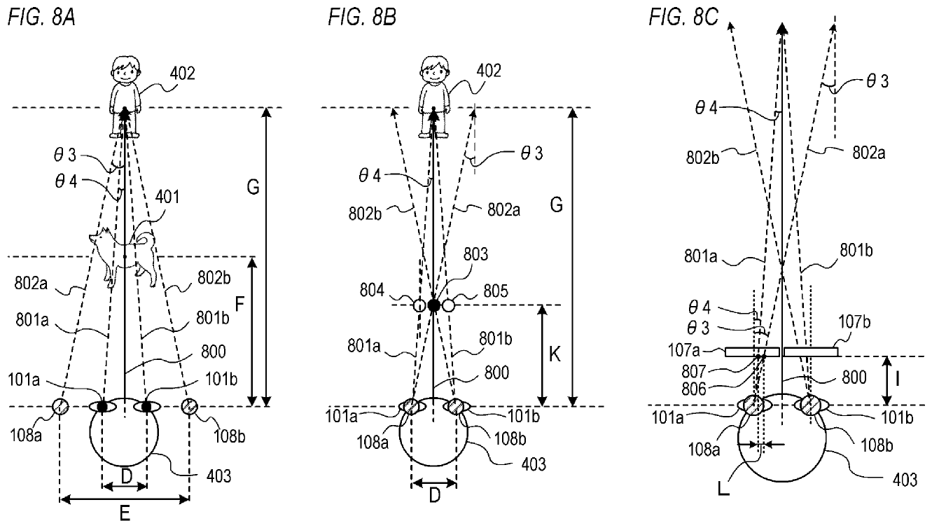

The processing of steps S302 to S307 for the person 402 will be described with reference to FIGS. 5A to 5F, FIGS. 8A to 8C, and Formulas 5 to 8. Since the person 402 and the dog 401 have different depth distances, the correction amounts in the left-eye image and the right-eye image are different between the person 402 and the dog 401. Detailed description of the same processing as the processing for the dog 401 will be omitted.

In step S302, the CPU 110 determines that the type of the person 402 is a correction target, and the processing proceeds to step S303. In step S303, the CPU 110 acquires the depth distance of the person 402.

A person 505 (person 402) in the left-eye image in FIG. 5A exists at a position 504 in the horizontal direction. A person 509 (corresponding to the person 505 in the left-eye image) in the right-eye image of FIG. 5B exists at a position 508 in the horizontal direction. The distance acquisition unit 114 can calculate a depth distance G from the HMD 100 to the person 505 (person 509) using the distance (position difference) between the position 504 and the position 508.

In step S304, the CPU 110 determines whether or not the depth distance of the person 402 is shorter than a predetermined threshold value. In the example of FIG. 4B, it is determined that the depth distance G of the person 402 is shorter than the predetermined threshold value, and the processing proceeds to step 305.

In step S305, the CPU 110 acquires the correction amount of the display position of the person 402. The processing of step S305 for the person 402 will be specifically described with reference to FIGS. 8A to 8C. FIG. 8A is a diagram for describing at what angle the person 402 is captured from each of the left eye 101a, the right eye 101b, the left imaging device 108a, and the right imaging device 108b.

It is assumed that a center line 800 is a straight line extending from the midpoint between the left and right eyes in the direction in which the person 402 exists. The left imaging device 108a captures the person 402 with a left imaging device line of sight 802a in which an angle formed with the center line 800 is an angle θ3. The right imaging device 108b captures the person 402 with a right imaging device line of sight 802b in which an angle formed with the center line 800 is the angle θ3. The angle θ3 is expressed by the following Formula 5 using the distance E between the left and right imaging devices and the depth distance G of the person 402.

$$\begin{matrix}[ Math . 5 ] & \\ {θ}_{3} = {tan}^{- 1} ( \frac{E / 2}{G} ) & ( Formula 5 )\end{matrix}$$

The left eye 101a captures the person 402 with a left-eye line of sight 801a in which an angle formed with the center line 800 is an angle θ4. The right eye 101b captures the person 402 with a right-eye line of sight 801b in which an angle formed with the center line 800 is the angle θ4. The angle θ4 is expressed by the following Formula 6 using the distance D between the left eye 101a and the right eye 101b and the depth distance G of the person 402.

$$\begin{matrix}[ Math . 6 ] & \\ {θ}_{4} = {tan}^{- 1} ( \frac{D / 2}{G} ) & ( Formula 6 )\end{matrix}$$

As schematically illustrated in FIG. 8B, the user 403 actually views images captured by the left imaging device 108a and the right imaging device 108b with his/her left eye 101a and right eye 101b, respectively. In the state of FIG. 8B, the left eye 101a captures the person 402 on the left imaging device line of sight 802a in which an angle formed with the center line 800 is the angle θ3, and the right eye 101b captures the person 402 on the right imaging device line of sight 802b in which an angle formed with the center line 800 is the angle θ3. In this case, the user 403 recognizes that the person 402 exists at a position 803 where the left imaging device line of sight 802a and the right imaging device line of sight 802b intersect. The depth distance K from the user 403 to the position 803 is expressed by the following Formula 7. A depth distance K is a distance shorter than the actual depth distance G from the user 403 to the person 402.

$$\begin{matrix}[ Math . 7 ] & \\ K = \frac{( D / 2 )}{tan {θ}_{3}} & ( Formula 7 )\end{matrix}$$

When the left eye 101a can capture the person 402 on the left-eye line of sight 801a and the right eye 101b can capture the person 402 on the right-eye line of sight 801b, the user 403 can capture the person 402 with an actual sense of distance and recognize that the person 402 exists at the position of the distance G from the user 403. In the depth distance K, it is only required to capture the person 402 by the left eye 101a at a position 804 on the left-eye line of sight 801a, and by the right eye 101b at a position 805 on the right-eye line of sight 801b. The CPU 110 corrects the display position of the person 402 with the left-eye image and the right-eye image, so that the left eye 101a and the right eye 101b can capture the person 402 at the position 804 and the position 805.

FIG. 8C is a diagram for describing the correction amount of the display position of the person 402 in the left-eye image and the right-eye image. A distance from the user 403 to the left display 107a and the right display 107b is I. Hereinafter, a method of calculating the correction amount for the left-eye image will be described, but the correction amount for the right-eye image can be calculated similarly to that of the left-eye image.

In a state where the person 402 is captured at the position 803 on the left imaging device line of sight 802a in FIG. 8B, the person 402 is displayed at the position 806 on the left display 107a in FIG. 8C. The person 402 is displayed at a position 807 where the left-eye line of sight 801a and the left display 107a intersect, so that the left eye 101a of the user 403 can capture the person 402 at the position 804 on the left-eye line of sight 801a in FIG. 8B. A distance L between the position 806 on the left imaging device line of sight 802a and the position 807 on the left eye line of sight 801a is a correction amount by which the person 402 is to be moved on the left display 107a. The distance L, which is a correction amount, is expressed by the following Formula 8.

$$\begin{matrix}[ Math . 8 ] & \\ L = I \cdot ( tan {θ}_{3} - tan {θ}_{4} ) & ( Formula 8 )\end{matrix}$$

Similarly, the person 402 is moved by the distance L in the direction away from the center line 800 on the right display 107b, so that the right eye 101b of the user 403 can capture the person 402 at the position 805 on the right-eye line of sight 801b of FIG. 8B.

In step S306 of FIG. 3, the CPU 110 cuts out an area of the person 402 from the left-eye image and the right-eye image, and moves the area of the person 402 cut out by the correction amount acquired in step S305.

The CPU 110 cuts out an image area of the person 505 at the position 504 on the left-eye image illustrated in FIG. 5A, and moves the image area by the correction amount (distance L) acquired in step S305. A person 514 illustrated in FIG. 5C is the person 505 of FIG. 5A moved to a position 513. In FIG. 5A, in the area where the person 505 is displayed before the correction, an area where the moved corrected person 514 is not displayed (an area not overlapping with the corrected person 514) is an occlusion area 515 where no image exists.

Similarly, the CPU 110 cuts out an image area of the person 509 at the position 508 on the right-eye image illustrated in FIG. 5B, and moves the image area by the correction amount (distance L) acquired in step S305. A person 520 illustrated in FIG. 5D is the person 509 in FIG. 5B moved to a position 519. In FIG. 5B, in the area where the person 509 is displayed before the correction, an area where the moved corrected person 520 is not displayed (an area not overlapping with the corrected person 520) is an occlusion area 521 where no image exists.

In step S307, the CPU 110 estimates and generates a background in the occlusion area generated in step S306. FIGS. 5E and 5F illustrate images in which backgrounds are estimated and generated for the occlusion areas 515 and 521 in FIGS. 5C and 5D, and the generated images are fitted. The CPU 110 estimates and generates an image of each occlusion area from an image around each of the occlusion area 515 in the left-eye image and the occlusion area 521 in the right-eye image. FIGS. 5E and 5F illustrate states in which the backgrounds are fitted into the occlusion areas 515 and 521 in FIGS. 5C and 5D, and the persons 505 and 509 in FIGS. 5A and 5B are moved to the positions of the persons 514 and 520, respectively.

The HMD 100 moves the display positions of the dog 401 and the person 402 by the respective correction amounts J and L. As described above, the HMD 100 can correct the display positions of a plurality of objects detected from the left and right captured images by the correction amounts based on the respective depth distances. The correction amounts of the plurality of objects detected from the left and right captured images vary depending on the depth distance of each object, and can be calculated by the algorithm described in the flowchart of FIG. 3 by the calculation method similar to Formulas 1 to 8.

In the example of FIG. 4A, the objects detected from the left and right captured images are two of the dog 401 and the person 402, and when the processing up to step S307 for each of the dog 401 and the person 402 is completed, it is determined in step S308 that there is no unprocessed object, and the processing illustrated in FIG. 3 ends.

According to the above embodiment, the HMD 100 corrects the display positions of the plurality of objects detected in the left-eye image and the right-eye image by the correction amounts based on the respective depth distances. By correcting the display positions in the left-eye image and the right-eye image, the HMD 100 can perform display control so that the plurality of objects existing at different depth distances are displayed at the respective actual depth distances. Therefore, the user wearing the HMD 100 can observe the plurality of objects having different depth distances with respective actual senses of distance.

In the above embodiment, the HMD 100 includes the left imaging device 108a and the right imaging device 108b that are imaging units, and the left display 107a and the right display 107b that are display units. On the other hand, the imaging unit may be provided in an external device, and the HMD 100 may acquire the left-eye image and the right-eye image transferred from the external device. The HMD 100 can execute a series of correction processing described in FIG. 3 on the image acquired from the external device, and display the image to which the series of correction processing has been applied on the left display 107a and the right display 107b. The HMD 100 outputs the corrected left-eye image and the corrected right-eye image to a storage unit such as the ROM 111, so that the corrected image can be displayed after the series of correction processing.

In addition, the left-eye image and the right-eye image may be recorded images input via an input unit of the HMD 100. The HMD 100 can execute the series of correction processing described in FIG. 3 on the recorded image data, and display the image to which the series of correction processing has been applied on the left display 107a and the right display 107b.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

According to the present disclosure, a plurality of objects existing at different depth distances can be controlled to be displayed at respective actual depth distances.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. An image processing device comprising:
a processor; and
a memory storing a program which, when executed by the processor, causes the image processing device to:
execute image acquisition processing of acquiring a first image for a right eye and a second image for a left eye;
execute distance acquisition processing of acquiring a depth distance of an object detected in the first image and the second image from a user; and
execute display control processing of controlling a display position of a first object on a display on a basis of a first depth distance that is the depth distance of the first object detected in the first image and the second image, and controlling a display position of a second object on the display on a basis of a second depth distance that is the depth distance of the second object detected in the first image and the second image.

2. The image processing device according to claim 1,
wherein, in the display control processing, a predetermined display position of the first object is corrected by a first correction amount based on the first depth distance, and a predetermined display position of the second object is corrected by a second correction amount based on the second depth distance.

3. The image processing device according to claim 2,
wherein, in the display control processing,
the first correction amount is acquired on a basis of the first depth distance, a distance between imaging devices that have individually captured the first image and the second image, and a distance between a left eye and a right eye of the user, and
the second correction amount is acquired on a basis of the second depth distance, a distance between imaging devices that have individually captured the first image and the second image, and a distance between a left eye and a right eye of the user.

4. The image processing device according to claim 2,
wherein, in the display control processing, in each of the first image and the second image,
an image of an area, where the first object is not displayed after a correction in an area where the first object has been displayed before the correction, is estimated and generated from an image around the first object, and
an image of an area, where the second object is not displayed after a correction in an area where the second object has been displayed before the correction, is estimated and generated from an image around the second object.

5. The image processing device according to claim 2,
wherein, in the display control processing, a display position of the object is corrected in a case where the object detected in the first image and the second image satisfies a predetermined condition.

6. The image processing device according to claim 5,
wherein the predetermined condition includes a condition that a type of the object is a predetermined type.

7. The image processing device according to claim 5,
wherein the predetermined condition includes a condition that the depth distance of the object is shorter than a predetermined threshold value.

8. The image processing device according to claim 2,
wherein, in the display control processing, a corrected first image and a corrected second image are output.

9. The image processing device according to claim 1,
wherein, in the image acquisition processing, the first image and the second image are acquired from an external device.

10. The image processing device according to claim 1,
wherein the first image and the second image are recorded images.

11. The image processing device according to claim 1,
wherein the depth distance of the object detected in the first image and the second image is a distance from the user to a center of the object.

12. A head mounted display comprising:
the image processing device according to claim 1;
an imaging device for capturing the first image and the second image; and
the display.

13. An image processing method comprising:
acquiring a first image for a right eye and a second image for a left eye;
acquiring a depth distance of an object detected in the first image and the second image from a user; and
controlling a display position of a first object on a display on a basis of a first depth distance that is the depth distance of the first object detected in the first image and the second image, and controlling a display position of a second object on the display on a basis of a second depth distance that is the depth distance of the second object detected in the first image and the second image.

14. A non-transitory computer readable medium that stores a program, wherein the program causes a computer to execute an image processing method comprising:
acquiring a first image for a right eye and a second image for a left eye;
acquiring a depth distance of an object detected in the first image and the second image from a user; and
controlling a display position of a first object on a display on a basis of a first depth distance that is the depth distance of the first object detected in the first image and the second image, and controlling a display position of a second object on the display on a basis of a second depth distance that is the depth distance of the second object detected in the first image and the second image.
